(19) United States
(12) Patent Application Publication
(10) Pub. No.: US 2023/0376874 A1
(43) Pub. Date: Nov. 23, 2023

(54) AN APPARATUS, METHOD AND COMPUTER PROGRAM PRODUCT FOR DETERMINING A LEVEL OF RISK

(71) Applicant: MASTERCARD INTERNATIONAL INCORPORATED, PURCHASE, NY (US)

(72) Inventors: Quentin Bragard, Dublin (IE); James Thomas Conway, Dublin (IE); Nitish Kothale, Dublin (IE)

(21) Appl. No.: 18/031,344

(22) PCT Filed: Oct. 6, 2021
(86) PCT No.: PCT/US2021/053718

§ 371 Date: Apr. 11, 2023

(30) Foreign Application Priority Data
Oct. 12, 2020 (GB) 2016132.9

(51) Int. Cl. G06Q 10/0635; G06Q 40/02

(52) U.S. Cl. CPC G06Q 10/0635; G06Q 40/02

(57) ABSTRACT

An apparatus for determining a level of risk that a future transfer will exceed a level of reserve is provided by the present disclosure, the apparatus comprising circuitry configured to: obtain data of transfers between financial institutions which have occurred at a number of instances of time, the data including transfer amounts; apply a predictive model to the data to obtain a prediction of the transfer amount at each instance of time; determine a maximum residual between the prediction of the transfer amount and the transfer amount at each instance of time; model the maximum residual for each instance of time using a generalised extreme value distribution to obtain a distribution function; and determine the level of risk that a future transfer between financial institutions will exceed the level of reserve based on the distribution function which has been obtained.

### CROSS-REFERENCE TO RELATED APPLICATION

This application claims the benefit of, and priority to, United Kingdom Patent Application No. 2016132.9, filed Oct. 12, 2020. The entire disclosure of the above application is incorporated herein by reference.

### FIELD OF THE DISCLOSURE

The present invention relates to an apparatus, method and computer program product for determining a level of risk that a future transfer will exceed a level of reserve.

### BACKGROUND

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present invention.

Modern communication technology has impacted the manner by which transfers, such as exchanges and transactions, are undertaken and performed. One type of transfer is an electronic transaction between two parties (such as a merchant and consumer). In an economy such as the United Kingdom, the number of electronic transactions may be very large. A significant number of these electronic transactions are made through payment systems (including payment rails and payment infrastructure (such as hardware and software components of communication networks)).

Often, transfers in a payment system are made during a transfer cycle or the like. That is, transfers are recorded during a first predetermined time interval. Then, at the end of the first predetermined time interval, the transfers are completed (with the net value of the transfers for the first predetermined time interval being exchanged between the participants).

However, given that the number of electronic transactions made through payment systems can be very large, the net value of transactions is computationally difficult to predict and there is a risk that a participant will be unable to settle their debt at the end of a predetermined time interval. That is, reserves of funds which the participant has may be insufficient to cover the net value of transactions which have occurred during the predetermined time interval. This causes significant risk, uncertainty and disruption throughout the payment system.

Accordingly, there is a need for a technical solution to this problem.

It is an aim of the present disclosure to address these issues.

### SUMMARY

According to a first aspect of the disclosure, an apparatus for determining a level of risk that a future transfer will exceed a level of reserve is provided, the apparatus being configured to: obtain data of transfers between financial institutions which have occurred at a number of instances of time, the data including transfer amounts; apply a predictive model to the data to obtain a prediction of the transfer amount at each instance of time; determine a maximum residual between the prediction of the transfer amount and the transfer amount at each instance of time; model the maximum residual for each instance of time using a generalised extreme value distribution to obtain a distribution function; and determine the level of risk that a future transfer between financial institutions will exceed the level of reserve based on the distribution function which has been obtained.

According to a second aspect of the disclosure, a method of determining a level of risk that a future transfer will exceed a level of reserve is provided, the method comprising the steps of: obtaining data of transfers between financial institutions which have occurred at a number of instances of time, the data including transfer amounts; applying a predictive model to the data to obtain a prediction of the transfer amount at each instance of time; determining a maximum residual between the prediction of the transfer amount and the transfer amount at each instance of time; modelling the maximum residual for each instance of time using a generalised extreme value distribution to obtain a distribution function; and determining the level of risk that a future transfer between financial institutions will exceed the level of reserve based on the distribution function which has been obtained.

According to a third aspect of the disclosure, a computer program product is provided comprising instructions which, when the program is executed by a computer, cause the computer to perform a method of determining a level of risk that a future transfer will exceed a level of reserve, the method comprising: obtaining data of transfers between financial institutions which have occurred at a number of instances of time, the data including transfer amounts; applying a predictive model to the data to obtain a prediction of the transfer amount at each instance of time; determining a maximum residual between the prediction of the transfer amount and the transfer amount at each instance of time; modelling the maximum residual for each instance of time using a generalised extreme value distribution to obtain a distribution function; and determining the level of risk that a future transfer between financial institutions will exceed the level of reserve based on the distribution function which has been obtained.

According to aspects of the present disclosure, an apparatus, method and computer program product are provided which provide a technical solution to reduce the computational resources required in order to predict the level of reserve which will be required in a settlement period and, furthermore, the level of risk that a future transfer or set of transfers will exceed the level of reserve.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an apparatus according to embodiments of the disclosure;

FIG. 2A illustrates an example situation to which embodiments of the disclosure may be applied;

FIG. 2B illustrates an example level of reserve according to embodiments of the disclosure;

FIG. 3 illustrates an example configuration of an apparatus according to embodiments of the disclosure;

FIG. 4 illustrates an example of clustering according to embodiments of the disclosure;

FIG. 5A illustrates a set of example distributions according to embodiments of the disclosure;

FIG. 5B illustrates an example distribution according to embodiments of the disclosure;

FIG. 6 illustrates a method according to embodiments of the disclosure.

### DESCRIPTION OF THE EMBODIMENTS

Referring now to the drawings, wherein like reference numerals designate identical or corresponding parts throughout the several views.

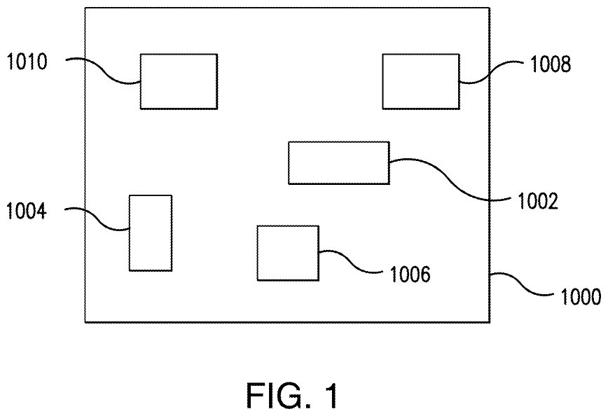

Referring now to FIG. 1 of the present disclosure, an apparatus 1000 according to embodiments of the disclosure is illustrated. Typically, apparatus 1000 according to embodiments of the disclosure is a computer device such as a personal computer or a terminal connected to a server. Indeed, in embodiments, the apparatus may also be a server. The apparatus 1000 is controlled using a microprocessor or other processing circuitry 1002.

The processing circuitry 1002 may be a microprocessor carrying out computer instructions or may, alternatively, be an Application Specific Integrated Circuit. The computer instructions are stored on storage medium 1004 which maybe a magnetically readable medium, optically readable medium or solid state type circuitry. The storage medium 1004 may be integrated into the apparatus 1000 or may be separate to the apparatus 100 and connected thereto using either a wired or wireless connection. The computer instructions may be embodied as computer software that contains computer readable code which, when loaded onto the processor circuitry 1002, configures the processor circuitry 1002 to perform a method according to embodiments of the disclosure.

Additionally connected to the processor circuitry 1002, is a user input 1006. The user input 1006 may be a touch screen or may, alternatively, be a mouse or stylist type input device. The user input 1006 may also be a keyboard or any combination of these devices. The user input 1006 thus enables a user to instruct apparatus 1000 to perform certain operations or the like.

A network connection 1008 is also coupled to the processor circuitry 1002. The network connection 1008 may be a connection to a Local Area Network or a Wide Area Network such as the Internet or a Virtual Private Network or the like. The network connection 1008 may further be connected to banking infrastructure thus allowing the processor circuitry 1002 of apparatus 1000 to communicate with other banking institutions to obtain relevant data or provide relevant data to the institutions. The network connection 1008 may therefore be behind a firewall or some other form of network security.

Additionally coupled to the processing circuitry 1002, is a display device 1010. The display device 1010, although shown integrated into the apparatus 1000, may additionally be separate to the apparatus 1000 and may be a monitor or some kind of device allowing the user to visualise the operation of the system. In addition, the display device 1010 may be a printer or some other device allowing relevant information generated by the apparatus 1000 to be viewed by the user or by a third party.

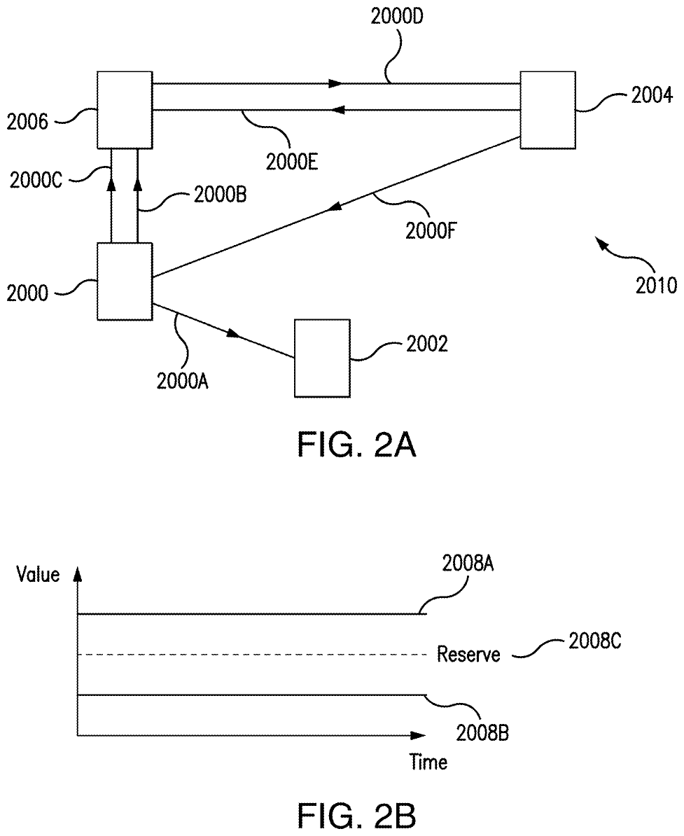

Referring now to FIG. 2A of the present disclosure, an example situation to which embodiments of the disclosure may be applied is illustrated.

Specifically, a payment network 2010 is illustrated in FIG. 2A. Within this payment network 2010, a number of distinct financial institutions 2000, 2002, 2004 and 2006 are located. These financial institutions may be any type of financial institution including banks mortgage companies or the like. Each financial institution holds a number of accounts, those accounts belonging to merchants and/or consumers. The accounts of an individual merchant or consumer are used to store funds with the financial institution such that the merchant or consumer can participate in transactions with other merchants and/or consumers.

The financial institutions 2000, 2002, 2004 are each able to participate in transactions (and other types of transfers) on behalf of merchants and/or consumers. However, not all accounts are held by the same financial institution. For example, a merchant may have an account with a financial institution 2006 and a consumer, who wishes to purchase goods from the merchant, may have an account with financial institution 2004. Accordingly, when the consumer initiates a transfer 2000E to the merchant, the consumer's financial institution 2004 owes the merchant's financial institution 2006 the value of the transaction. This debt creates a level of risk within the payment system.

In the payment network 2010, individual payments are collectively completed within an instance of time, the instance of time being known as the settlement period. That is, transactions (and other transfers) are recorded during a first predetermined time interval (i.e. the settlement period). Then, at the end of the first settlement period, the transfers are completed (with the net value of the transfers for the first predetermined time interval being exchanged between the financial institutions of the participants). In other words, the individual payment associated with a transfer is completed by the financial institutions at the end of the corresponding settlement period.

In fact, a number of further transfers may be recorded within the settlement period in addition to transaction 2000E (a type of transfer) between financial institution 2004 and 2006. For example, as illustrated in FIG. 2, within the settlement period, a transfer 2000B between financial institution 2005 and 2004, two transfers 2000C and 2000B between financial institution 2000B and 2004, a transfer 2000A between financial institutions 2000 and 2002 and a transfer 2000F between financial institutions 2004 and 2000 are recorded.

Accordingly, at the end of the settlement period, financial institution 2000 has to provide funds to financial institution 2006 to cover the transfers 2000C and 2000B. Financial institution 2000 must also provide funds to financial institution 2002 to cover transfer 2000A. The funds to cover these transfers are made out of a reserve of funds held by financial institution 2000. However, at the end of the settlement period, financial institution 2000 receives funds from financial institution 2004 to cover the transfer 2000F. This comes from the reserves of financial institution 2004.

In contrast, at the end of the settlement period, the net value of transfers (being the difference between transfer 2000E and 2000D) will be exchanged between financial institutions 2006 and 2004. That is, if the value of transfer 2000E was greater than transfer 2000D then financial institution 2006 will receive the net value of the transfers from financial institution 2004. However, if the value of transfer 2000E was less than transfer 2000D then financial institution 2006 will send the net value of the transfers to financial institution 2004.

The number of transfers which are made during a settlement period is not limited to the transfers illustrated in FIG. 2. In fact, in an economy such as the UK, a very large number of transfers may be made during each settlement period. Recently, there has been a rapid increase in the number of inter-bank transfers of this kind. In fact, there is a need for transactions, and other kinds of transfers, to be settled in very short time intervals (thus leading to a reduction in the length of the settlement period).

Owing to the vast number of transfers which occur during a settlement period, there is a risk that a financial institution will have insufficient funds in order to settle at the end of the settlement period.

That is, owing to uncertainty in the number of transfers which will be made during a settlement period and fluctuations regarding the values of those transfers there is a risk that the net transfer of funds during a settlement period from a financial institution will exceed the level of reserve held by the financial institution for that settlement period.

Consider FIG. 2B of the present disclosure. FIG. 2B illustrates an example level of reserve according to the example situation of FIG. 2A of the present disclosure. That is, the value of reserve maintained by financial institution 2008C during a first settlement period is illustrated. The cumulative net value of transfers which have occurred within the settlement period with respect to financial institution 2000 is illustrated.

That is, in a first example, the cumulative net value of transfers during the settlement period is 2008B. Here, the cumulative net value of transfers including financial institution 2000 (i.e. 2000C, 2000B, 2000F and 2000A) is less than the level of reserve held by financial institution 2000. Accordingly, at the end of the settlement period, financial institution 2000 is able to settle its debts.

However, in a second example, the cumulative net value of transfers which have occurred within the settlement period with respect to financial institution 2000 is 20008A. Here, the funds which are required in order for financial institution 2000 to settle its debts at the end of the settlement period exceed the level of reserve 2008C. Specifically, the difference between the outbound transfers (i.e. 2000C, 2000B and 2000A) and the inbound transfer (i.e. 2000F) in the settlement period exceeds the level of reserve 2008C. Accordingly, in this second example, financial institution 2000 has insufficient funds in order to settle its debts at the end of the settlement period.

The inability of the financial institution 2000 to settle its debts at the end of the settlement period causes significant risk, uncertainty and disruption throughout the payment network. Having an insufficient level of reserve in order to settle the debts arising during a settlement period at the end of that settlement period has significant business and regulatory impact. That is, in the case of having insufficient reserves, the financial institution is often required to borrow additional funds (e.g. from a central bank or central financial institution) in order to be able to settle its debts. However, additionally, having an insufficient level of reserve has a significant technical impact on the system, leading to an increase in system overheads as requests for additional resources are produced and/or as transactions during the settlement period are disrupted. Furthermore, failure to be able to settle debts at the end of a first settlement period may also cause significant impact and disruption on subsequent transfers occurring during subsequent settlement periods.

Owing both to the vast number of transfers which are performed within a settlement period and the complexity of the situation regarding such transfers, it is computationally very demanding to predict the level of reserve which will be required in a settlement period.

Accordingly, an apparatus for determining a level of risk that a future transfer will exceed a level of reserve is provided.

<Apparatus>

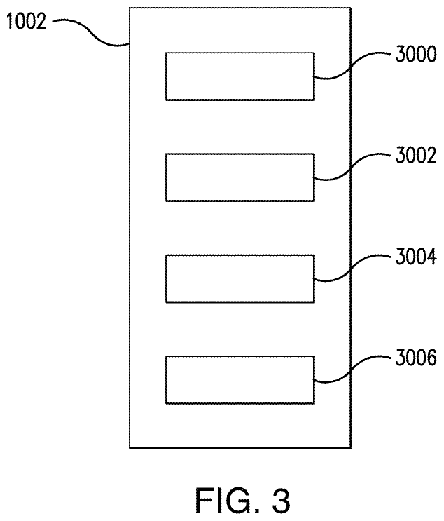

FIG. 3 illustrates an example configuration of an apparatus according to embodiments of the disclosure. Specifically, an example configuration of the processing circuitry of apparatus 1000 is illustrated in FIG. 3. The circuitry 1002 of apparatus 1000 comprises an obtaining unit 3000, an application unit 3002, a determining unit 3004 and a modelling unit 3006.

According to embodiments of the disclosure, the obtaining unit 3000 is configured to obtain data of transfers between financial institutions which have occurred at a number of instances of time, the data including transfer amounts. The application unit 3002 is configured to apply a predictive model to the data to obtain a prediction of the transfer amount at each instance of time. The determining unit 3004 is configured to determine a maximum residual between the prediction of the transfer amount and the transfer amount at each instance of time. The modelling unit 3006 is, then, configured to model the maximum residual for each instance of time using a generalised extreme value distribution to obtain a distribution function. Finally, the determining unit 3004 is further configured to determine the level of risk that a future transfer between financial institutions will exceed the level of reserve based on the distribution function which has been obtained.

Further features of the obtaining unit 3000, the application unit 3002, the determining unit 3004 and the modelling unit 3006 will now be described with reference to the example situation of FIG. 2 of the present disclosure.

<Obtaining Unit>

As described above, circuitry 1002 of apparatus 1000 comprises an obtaining unit 3000 configured to obtain data of transfers between financial institutions which have occurred at a number of instances of time, the data including transfer amounts. This data, obtained by the obtaining unit, is used in order to determine a level of risk that a future transfer will exceed a level of reserve.

The manner of obtaining the data of transfers in accordance with embodiments of the disclosure is not particularly limited. For example, in some situations, the data may be received by means of a wired or wireless connection. This connection may be a connection with an external data service or data provider. Alternatively, the data of transfers may be stored within a storage internal to apparatus 1000. In this case, the data may be obtained directly from the internal storage by the obtaining unit 3000. In other examples, the data may be obtained from a central database, or a database linked, individually, to the participating financial institutions. Once obtained, the data of transfers may be stored within a readily accessible secure storage such that the data can be accessed by the other units (e.g. the application unit 3002) of the apparatus 1000.

In the example described with reference to FIG. 2A of the present disclosure, the data is data of transfers between financial institutions. For example, with reference to financial institution 2004, the data may include information regarding the transfer 2000E between financial institution 2004 and 2006, the transfer 2000D between financial institution 2006 and 2004, and the transfer 2000F between financial institution 2004 and 2000. For each of these transfers, the data may include the originating financial institution, the destination financial institution, the payment amount (that is, the value of the transfer) the individual account details of the transfer, date and time information regarding the transfer, and the like. In certain example situations, the data may be data regarding inter-bank transfers or the like.

However, it will be appreciated that the data which is obtained by obtaining unit 3000 is not limited to transfers which have occurred during the current time period. That is, taking the example situation of FIG. 2A of the present disclosure, the data is not limited to data of the transfers which have occurred in the present settlement period. Rather, the data further comprises data regarding transfers which have occurred in previous settlement periods.

In examples, the data which is obtained is historic data of transfers which have occurred in previous settlement periods. This historic data of previous transfers is used, by the application unit 3002, in order to produce a prediction of the values of future transfers which may occur. It will be appreciated that the number of previous settlement periods for which data is obtained, and thus the number of historic transfers for which data is obtained, may be quite large. In fact, increasing the number of historic transfers which are considered will increase the accuracy of the model in determining the level of risk that a future transfer will exceed a level of reserve. Therefore, the obtaining unit 3000 may be configured to obtain the data of the transfers between financial institutions at a number of instances of time in the past or, in some examples, for all previous instances of time for which that data is available.

In other examples, the obtaining unit may be configured to obtain data of transfers which have occurred at a previous instance of time only for transfers which have occurred within a specific interval or window of time. In particular, this may be advantageous if it is determined that certain historic data transfers should be excluded from the data, those certain historic data transfers having less relevance to the current example situation. This may be, for example, if data regarding certain transfers which occurred within an interval is unsuitable or corrupted. Instructions regarding the type of data which should be obtained by obtaining unit 3000 may be provided to apparatus 1000 by a controller through user input 1006, for example.

It will be appreciated that the form of the data itself is not particularly limited and will depend upon the situation to which the embodiments of the disclosure are applied. However, in certain examples, the data may be in a standard format which is used by each of the financial institutions included within the payment network. Furthermore, it will be appreciated that the data may, additionally, be encrypted (through public/private key encryption or the like) in order to further improve the security of the system. In some examples, the data may be stored within database system on a central server or the like.

Once the data of the transfers which have occurred at a previous instance of time have been obtained by the obtaining unit, the data can be provided, either directly or indirectly, to the application unit 3002.

<Application Unit>

As described above, apparatus 1000 comprises an application unit 3002 configured to apply a predictive model to the data to obtain a prediction of the transfer amount at each instance of time.

The application unit receives the data which has been obtained by the obtaining unit 3000 of apparatus 1000. This data may be received directly or, alternatively, indirectly be means of a common central memory or storage or the like. The application unit applies a predictive model to the data of previous transfers, and, on the basis of the predictive model, predicts the value of transfers for a future time interval. In some example, the predictive model is trained on the data provided by the obtaining unit 3000. In other examples, the predictive model has already been trained, and is thus applied directly to the data provided by the obtaining unit 3000 in order to produce the prediction.

In certain examples, the predictive model may be a vector autoregressive moving average model (VARMA). The use of a VARMA model as the predictive model by application unit 3002 may be particularly advantageous when working with a system comprising a multivariate time series (i.e. when the past history of the system as a whole has more predictive power than the history of a single series itself). However, other predictive models can be used in accordance with embodiments of the disclosure. For example, more generally, Autoregressive Moving Average Models can be used by application unit 3002. In fact, any such predictive model, including machine learning models such as neural networks or the like, can be applied by application unit 3002 depending on the form and type of data which has been obtained by obtaining unit 3000. In other words, the ability of apparatus 1000 to determine a level of risk that a future transfer, or set of transfers, will exceed the level of reserve is, largely, independent on the of predictive model used, provided that the predictive model is able to analyse the previous data and produce a prediction on that basis.

As noted above, the data received by the obtaining unit may be used, by the application unit 3002, to train the predictive model. That is, the predictive model is a model which can be used to understand certain variations within historic data and, then, based on those variations within the historic data, provide certain predictions of future values. However, in order to provide those predictions the model must first be trained on the historic data.

Training the predictive model on the data of the transfers may, in certain embodiments, comprise splitting the data into a training set and a validation set. The predictive model can then be trained on the training set portion of the data obtained by the obtaining unit, with the trained predictive model subsequently being validated by applying the predictive model to certain information regarding the validation set in order to identify whether the predictive model accurately predicts the transfer amounts for the data in the validation set. If the predictive model accurately predicts the transfer amounts for the data in the validation set, then it can be determined that the predictive model has been successfully trained and can be applied to predict transfer values for future periods of time. However, if the predictive model does not successfully predict the transfer values for the validation set, then it can be determined that further training of the predictive model is required. Determination as to whether the model successfully predicts the transfer values for the validation set may be based upon an identification as to whether the predicted values are within a certain predetermined threshold or range of the values in the validation set. The predetermined threshold value may be set in advance by a user or controller, and may vary depending upon the required levels of accuracy for a given situation.

The data obtained by the obtaining unit can be separated into the training set and the validation set by any appropriate means, which may vary depending on the structure of the data itself. For example, in some example situations a certain portion of the data, such as the most recent portion of the data, can be reserved as the validation data. However, in other examples, a rolling window can be used to separate the data into a training set and a validation set as required.

In certain examples, such as when the predictive model is a VARMA model, the application unit may further be configured to train the predictive model on additional training data of transfers between financial institutions which have occurred at a number of instances of time, the training data including transfer amounts. The additional training data may include training data from external payment networks, training data from additional time periods and/or training data from simulated transfers. The use of additional training data may be particularly advantageous for supplementing the data which has been obtained by the obtaining data in order to further improve the accuracy of the model. Alternatively, the use of additional training data may be required in order to provide additional training for the predictive model in the event that the predictive model does not successfully predict the values of the transfers for the validation set.

Increasing the volume and range of data on which the predictive model is trained may, in general, further improve the accuracy of the predictive model at predicting certain future values of transfers. However, there is a trade-off insofar as increasing the volume and range of data increases both the time and computational resources which are required in order to train the predictive model.

Accordingly, in certain examples, due to the large volume of data, the inventors have identified that it may be particularly advantageous to apply certain clustering techniques to the data in order to further improve the efficiency of the system. As such, in certain examples, the application unit 3002 may be further configured to apply a clustering algorithm to the training data prior to training the predictive model. Clustering the training data classifies each data point of the training data into a specific group. Data having similar properties (occurring at a similar time or being a transfer between the same parties and/or individuals or the like) can be collected into a group, with the group providing an average or representative value of the data within that group (or cluster). The representative value may be the value of a selected data point within that cluster. The predictive model can then be trained on the clustered training data, reducing the number of individual data points on which the model must be trained. That is, the application unit 3002 may further be configured to partition the training data into a number of clusters, each cluster represented by one of the data within that cluster, and associates the total value of transfer amounts for data within that cluster as the transfer amount for that cluster.

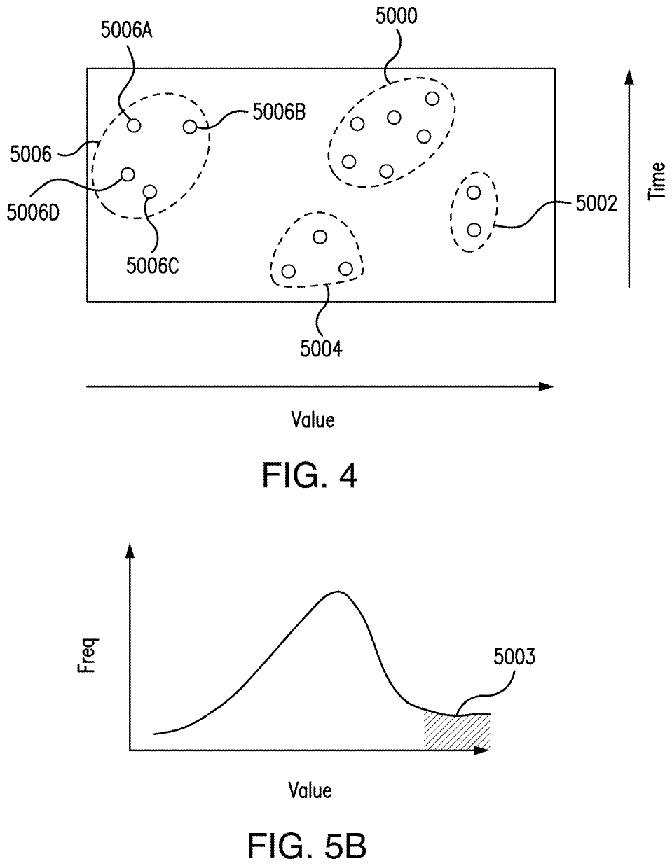

An example of clustering of the training data is illustrated in FIG. 4 of the present disclosure. In this example, a plot of the value of transfers against time is shown. Individual data points from the training data, such as 5006A, 5006B, 5006C and 5006D, are placed on the plot of value of transfers against time. This data is then clustered into a number of distinct clusters 5000, 5002, 5004 and 5006. The number of data points within each cluster, and the number of clusters which are produced, are not limited to this example. In this example, it can be seen that the individual data points 5006A, 5006B, 5006C and 5006D occur within a specific region of the parameter space. Therefore, these values have been clustered as a single cluster 5006. Of these values within the cluster 5006, a certain value such as 5006D may be selected as the representative value for that cluster. Accordingly, when the predictive model is applied to the training data, the clusters 5000, 5002, 5004 and 5006 are provided to the predictive model as four, distinct, data points, with a representative value (such as 5006D for cluster 5006) being used as the value of the transfer for each cluster accordingly.

While, in this specific example, the data has been clustered in accordance with the time distribution and value of the transfers, it will be appreciated that the present disclosure is not particularly limited in this respect. That is, clustering techniques of the present disclosure may be applied based on any of the information or parameters included in the data which is obtained by the obtaining unit 3000.

Use of clustering as illustrated within the example of FIG. 4 significantly reduces the volume and complexity of the data upon which the predicative model is trained without substantially affecting the accuracy of the model which is produced. Therefore, clustering of the training data enables the predictive model to be efficiently trained with reduced training time.

There are a number of specific clustering techniques which may be applied in order to cluster the data. The clustering technique which is applied by application unit 3002, may vary in accordance with the specific type and form of the data to which the predictive model is being applied.

In certain examples, a k-medoids algorithm may be applied to the data. The k-medoids cluster partitions the data into k groups or clusters, with each cluster being represented by one of the data points in the corresponding cluster. Furthermore, an average silhouette method may be used in order to estimate the optimal number of clusters into which the data should be clustered. This is a particularly fast and efficient mechanism for clustering the training data. The average silhouette method is a technique which enables an estimation to be made as to how well each object lies within its cluster. A high average silhouette indicates a good level of clustering. Accordingly, the optimum number of clusters is the number of clusters that maximizes the average silhouette over a range of possible number of clusters. The range of possible number of clusters may be set based on certain computational requirements of the system; that is, a maximum number of clusters may be set which ensures that the clustering approach still provides a certain level of reduction of the data. While the average silhouette method provides a particularly efficient mechanism for determining the number of clusters, it will be appreciated that other approaches, such as the Elbow method may also be applied in accordance with embodiments of the disclosure.

Furthermore, it will be appreciated that the present disclosure is not particularly limited to the k-medoids clustering approach. In certain situations, a k-means clustering approach, mean-shift clustering approach or an Expectation-Maximization clustering approach, or the like can be applied to the training data by the application unit 3002. The clustering approach used to cluster the training data will vary in accordance with the type of data and the specific situation as required.

Once clustered, the training data can be used to train the predictive model in the same manner as for the un-clustered training data (with a certain selected or representative value being used for each cluster).

Accordingly, during training, the data of previous transfers (including transfer amounts) is provided to the predictive model for the training data. The predictive model (such as the VARMA model) is then used to identify patterns, sequences and trends within the data, and the relationship between these patterns, sequences and trends with the transfer amounts. Then, once trained, the data of previous transfers (excluding transfer amounts) is applied to the trained predictive model, with the predictive model predicting the transfer amounts for the validation data.

However, as noted above, in certain examples, the predictive model may be applied directly to the data obtained by the obtaining unit in order to obtain the predicted values of transfers. That is, the predictive model which is used may have been trained on previous data. In this situation, the application unit 3002 applies the trained predictive model (being the previously trained model) directly to the data.

The trained predictive model is then applied to the data obtained from the obtaining unit 3000 as a whole, in order to determine, for each transfer, a predicted value of the transfer at that time. In some examples, the prediction may be made, individually, for each transfer within a settlement period. However, in other examples, the prediction may be made collectively for the transfers within a future settlement period (indicating the net transfers of funds for a financial institution within a settlement period).

<Determining Unit>

As described above, the determining unit 3004 is configured to determine a maximum residual between the prediction of the transfer amount and the transfer amount at each instance of time.

In other words, once the application unit 3002 has applied the predictive model to the data, in order to determine the predicted value of each transfer, the determining unit is configured to calculate a difference between the predicted value of the transfer and the value of the transfer which was actually observed for each instance of time. That is, it will be appreciated that the predictive model applied by the application unit 3002 will not, necessarily, produce a prediction which matches, exactly, the predicted value of the transfer for all the data which has been obtained. Rather, there may be a residual between the predicted value and the actual transfer amount.

By determining the residuals, or errors, in the predictive model, it is possible to separate the deterministic portion of the settlement values from the stochastic. The stochastic portion of the settlement values (being the values of the transfers) can be analysed in order to provide a predication as to whether a future transfer, or set of transfers, in a settlement period, will exceed a level of reserve (with that level of reserve being set based on the predicted value from the predictive model).

Accordingly, the determining unit determines the residuals between the predicted values of transfers and the actual, observed, values of the transfers for each previous instance of time (such as each previous settlement period). The maximum residual in each settlement period is then identified by the determining unit (being the largest residual, by magnitude, of the residuals within that settlement period).

Consider, again, the example of FIG. 2A of the present disclosure. Here, the transfers occurring in a single settlement period are illustrated. The trained predictive model will predict, for each transfer, a predicted value of the transfer. The determining unit 3004 then calculates, for each of these transfers, the difference between the predicted value of the transfer and the actual value of the transfer. For example, transfer 2000D may have a predicted value of £98 and an actual value of £100. The residual for transfer 2000D is therefore £2. In contrast, transfer 2000B may have a predicted value of £55 and an actual value of £50. The residual for transfer 2000B is therefore £5. Assuming that none of the other transfers occurring in the settlement period illustrated in FIG. 2A have a residual value exceeding that of transfer 2000B, transfer 2000B is subsequently selected as the transfer having the largest value of the residual. In other words, in this specific example, the maximum residual for the settlement period is determined, by the determining unit, as £5.

While described here with reference to the settlement period illustrated in FIG. 2A of the present disclosure, it will be appreciated that the above determination of the maximum residuals within the settlement periods may actually be determined for each previous settlement period for which the predictive model produces a prediction of the value of transfers.

Accordingly, as described above, the maximum residual is determined, for each instance of time (such as each settlement period) by the determining unit. These maximum values can then be used, by the modelling unit, to model the stochastic portion of the data and prediction.

<Modelling Unit>

As described above, the modelling unit 3006 is configured to model the maximum residual for each instance of time using a generalised extreme value distribution to obtain a distribution function.

In other words, once the individual maximum residuals for each instance of time (such as each settlement period) have been identified, a model can be applied to these maximum residuals in order to analyse the stochastic portion of the series which, in turn, enables an estimation of the required level of reserve and risk that the level of reserve will be exceeded.

Generalised extreme value (GEV) distributions belong to a set of continuous probability distributions. In particular, GEV distributions are able to provide an approximation, or estimation, of extreme values (such as maxima) within a sequence of random variables. In other words, a GEV distribution can be used in order to model the smallest or largest value among a set of independent, identically distributed random values representing measurements or observations. In fact, the GEV distribution is particularly efficient when applied to the situation of transfers between financial institutions, as it reduces the computational resources required to determine a level of risk that the level of reserve will be exceeded.

The GEV distribution is, typically, parameterized with a shape parameter, a location parameter and a scale parameter. Indeed, an example of a GEV distribution may be defined by the following equations:

GEV (μ, σ, ξ) (1)

where μ is a location parameter which satisfies μ ∈ R and which determines the “location” or shift of the distribution; σ is a scale parameter which satisfies σ>0 and which determines the “scale” or statistical dispersion of the probability distribution; and ξ a shape parameter which satisfies ξ ∈ R and which determines the “shape” of the distribution (rather than shifting or scaling the distribution).

The probability distribution function (Pdf) of the GEV may then be defined as:

$$Pdf : \frac{1}{σ} {t ( x )}^{ξ} {e}^{- t ( x )} \qquad ( 2 )$$

and the cumulative distribution function (Cdf) may be defined as:

Cdf:e^{-t(x)} (3)

where the parameter t is defined as:

$$t ( x ) = \{ \begin{matrix}{( 1 + ξ ( \frac{x - μ}{σ} ) )}^{\frac{- 1}{ξ}} \\ {e}^{\frac{- ( x - μ )}{σ}}\end{matrix} \} \begin{matrix}if ξ \neq 0 \\ if ξ = 0\end{matrix} \qquad ( 4 )$$

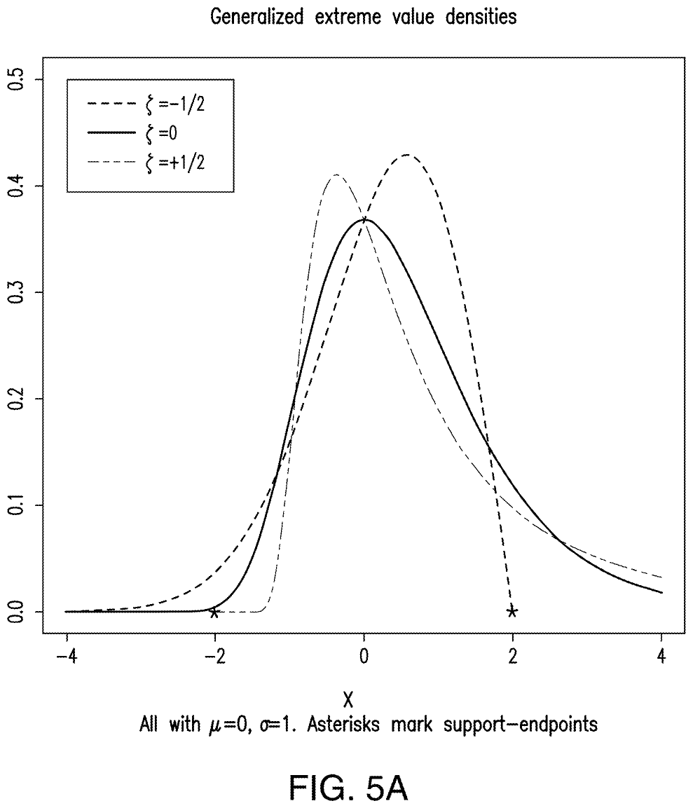

FIG. 5A of the present disclosure illustrates a set of example distributions in accordance with embodiments of the disclosure. In particular, probability distribution functions of the GEV distribution which were obtained from equations (1) to (4) of the present disclosure are shown. The density of the GEV is shown on the y-axis for different values of the parameter x in the range of −4 to +4. Three different probability distribution functions are shown corresponding to three different values of the shape parameter, being ξ=−1/2, ξ=0 and ξ=+1/2 respectively. Each of the three example probability distribution. functions shown in this example have the same values of the location parameter and the scale parameter, being μ=0 and σ=1 respectively. From these three examples, the impact on the probability distribution function of varying the value of the shape parameter ξ can be seen. As the value of ξ increases, the peak of the probability distribution function and the extent of the respective tails of the distribution can be seen to change accordingly.

Of course, it will be appreciated that the present disclosure is not particularly limited to these examples of the GEV distribution.

Now, fitting the GEV distribution to a sample of extremes, such as the sample of maximum residuals of transfers for each instance of time (e.g. each settlement period), enables the modelling unit 3006 to determine the value of these parameters which best fit the distribution of extremes. The manner of fitting the GEV distribution to the maximum residuals is not particularly limited. In some examples, an automated fitting approach (such as a least squares fitting approach or the like) can be used in order to fit the GEV distribution to the maximum residuals and, thus, determine the optimum values of the parameters of the GEV distribution.

FIG. 5B of the present disclosure illustrates a distribution function which may be obtained by fitting a GEV distribution to the maximum residuals determined by the determining unit 3004. The value of the residual (i.e. the maximum residual) is provided on the x-axis, while the frequency of that level of residual occurring, is provided on the y-axis. Applying the GEV distribution to the maximum residual which has been determined in each settlement period therefore provides a model of the maximum residuals between the predicted model and the actual, observed values of the transfers. This produces a probability distribution function of the maximum residuals of the model, and therefore enables the inferences about the probability of rare or extreme events to be made (such as the residuals between the predicted transfer amount and the actual transfer amount exceeding the level of reserve).

The actual distribution which is produced by modelling unit 3006 when fitting the GEV distribution to the data is not limited to this specific example. Rather, it will vary in accordance with the data obtained by obtaining unit 3000 and the maximum residuals which have been determined by determining unit 3004.

A prediction of the likelihood of the residual (or error) between the actual value of the transfer and the predicted value of the transfer exceeding a certain amount to be obtained can then be provided, by the determining unit 3004, based on the distribution.

<Level of Risk>

Once the modelling unit has applied the GEV distribution to the maximum residuals for each instance of time, the determining unit 3004 is configured to determine, from the resulting probability distribution function, the level of risk that a future transfer between financial institutions will exceed the level of reserve.

In certain examples, as described above, the determining unit 3004, may be the same determining unit 3004 as that which determines the maximum residuals for each instance of time. However, in other examples, the determining unit which determines the level of risk that a future transfer between financial institutions will exceed the level of reserve may be functionally, physically or otherwise separate from the determining unit 3004 which determines the maximum levels of the residuals. The present disclosure is not particularly limited in this regard.

Returning now to the example of FIG. 5B of the present disclosure, the determining unit 3004 is configured to determine, based on the distribution obtained from fitting the GEV distribution to the maximum residuals, the likelihood of future transfers exceeding a level of reserve. In particular, consider the situation where the level of reserve (such as reserve 2008C described with reference to FIG. 2B of the present disclosure) is set, for a given instance of time (such as a given settlement period) at a certain value based upon the predictive model. That is, the predictive model is used to set a certain level of reserve based upon the value of transfers. The determining unit can determine, based on the distribution (such as that illustrated in FIG. 5B of the present disclosure) the likelihood that a certain extreme value residual between the model and the predicted transfers will occur which result in the level of reserve being exceeded. In the example of FIG. 5B, these certain extreme value residuals correspond to the shaded region 5002 of FIG. 5B.

In certain examples, the determining unit 3004 may further be configured to estimate a probability density function and/or a cumulative density function through maximum likelihood estimation from the distribution function, and determine the level of risk that a future transfer between financial institutions will exceed the level of reserve based on the probability density function and/or the cumulative density function. That is, once the probability density function and/or the cumulative density function have been determined, these functions are analysed by the determining unit to identify the likelihood that a certain transfer will exceed a level of reserve.

In certain examples, the level of risk may be expressed as a number for which the level of reserve is exceeded less than once in every corresponding number of instances in time. For example, if the level of reserve is set to a certain predetermined value, then analysis of the distribution function enables a “1 in X” value to be obtained, being a value which is exceeded less often than once every X time points. In some examples, the value of X time points may be a number of instances of time (such as a number of settlement periods). Alternatively, the value of X time points may be expressed in terms of an explicit time period (such as days, weeks, months or years). Accordingly, a level of risk that the level of reserve will be exceeded in future transfers can be expressed in terms of the likelihood of the even occurring (e.g. there is a 1 in 10 year risk that the current level of reserve will be exceeded).

In certain examples, apparatus 1000 may further be configured to generate a flag based on the level of risk which has been determined. Specifically, apparatus 1000 may set a flag to notify an external operator or system that there is a high level of risk that the level of reserve will be exceeded will occur within a predetermined period of time. This may be when a risk that the level of reserve will be exceeded within a predetermined period of time exceeds a predetermined threshold, for example. The predetermined threshold value may be set, by an external operator, with respect to certain factors regarding the individual situation.

Advantageously, by notifying the external operator or system in this manner, it is possible to take certain actions in order to adjust the level of reserve and/or mitigate the impact of exceeding the level of reserve.

In fact, in certain example situations, wherein the circuitry may further be configured to indicate an adaptation of the level of reserve based on the level of risk which has been determined. That is, if it is determined that there is an exceedingly low probability that the level of reserve will be exceeded, apparatus 1000 may, optionally, indicate that the level of reserve being retained for each instance of time (such as each settlement period) is too high. In this situation, in order to prevent unnecessary levels of liquidity being locked up as reserve for each instance of time, the apparatus may indicate that the level of reserve may be safely reduced by a certain amount (with the resultant level of reserve maintaining a very low probability of being exceeded). Alternatively, it may be determined that there is a significant risk that the current level of reserve will be exceeded. In this situation, the apparatus 1000 may, optionally, indicate that the level of reserve should be increased. Furthermore, in this situation, apparatus 1000 may indicate the amount by which the level of reserve should be increased in order that the level of risk of the reserve being exceeded is reduced to an appropriate or desired level.

Therefore, by determining the level of risk in this manner, it is possible to reduce the likelihood that the future transfer, or set of transfers, will exceed the level of reserve. In the example of inter-bank transfers between financial institutions during a settlement period, this enables banks (and other financial institutions) to identify what their expected liquidity requirements are to cover their settlement obligations ahead of time. Furthermore, it is possible for user and/or regulators (such as a central bank or the like) to define the required level of liquidity reserve held by individual banks such that the risk of the reserve being exceeded is reduced to an appropriate or desired level.

<Advantageous Technical Effect>

According to embodiments of the disclosure, an apparatus 1000 is provided which provides a technical solution to reduce the computational resources required in order to predict the level of reserve which will be required in a settlement period and the level of risk that a future transfer will exceed the level of reserve.

The advantageous technical effects provided by embodiments of the disclosure are not particularly limited to the above, and further advantageous technical effects may be provided as will be apparent to the skilled person.

<Additional Modifications>

In certain examples, there may be a situation whereby the level of reserve is exceeded in a settlement period. This may occur more frequently when there is a high level of risk that the level of reserve will be exceeded (i.e. if the level of reserve is set too low). However, the level of reserve may also be exceeded even if there is a low level of risk of that event occurring. This may arise, for example, owing to an unexpectedly high residual between the predictive model and the actual transfer. Such an unexpectedly high residual between the predictive model may, in some examples, occur based merely on the stochastic nature of the transfers. However, in certain situations, if the level of reserve is exceeded even when there is very low likelihood of the level of reserve being exceeded, it may be that a change of the underlying distribution has occurred and/or the predictive model needs re-training (that is, the likelihood of an extreme residual occurring was higher than predicted by the model).

In certain situations, the predictive model may be retrained as each new instance of time progresses (such as once each new settlement period has been completed). However, there is a trade-off insofar that updating the model after the completion of each new settlement period may be particularly computationally expensive. This may be the situation, for example, whereby the number of settlement periods is high (owing to a shorter interval for each settlement period) and/or where the number of transfers per settlement period is high (owing to an increased number of transfers).

Accordingly, in certain situations, it may be particularly advantageous to update the model (that is, re-train the predictive model on new data of the most recent settlement periods) only when the level of reserve is unexpectedly exceeded. That is, apparatus 1000 may, further, be configured to include future transfers exceeding the level of reserve in the training data to form new training data, and train the predictive model on the new training data. In this way, the predictive model can be updated to increase accuracy of prediction (by reflecting the events which were not satisfactorily modelled by the previous training data) while reducing the computational burden of continually updating the predictive model as new data becomes available.

Alternatively, in certain examples, the training model may be updated and/or retrained at regular intervals (such as once every week or month, for example). This further reduces the computational burden of continually updating the predictive model as new data becomes available, and also ensures that, even if an extreme event does not occur, the predictive model is frequently updated to reflect the most recent data (e.g. the transfers which have occurred in the settlement periods which have occurred after the model has been trained on the original data obtained by the obtaining unit).

<Method>

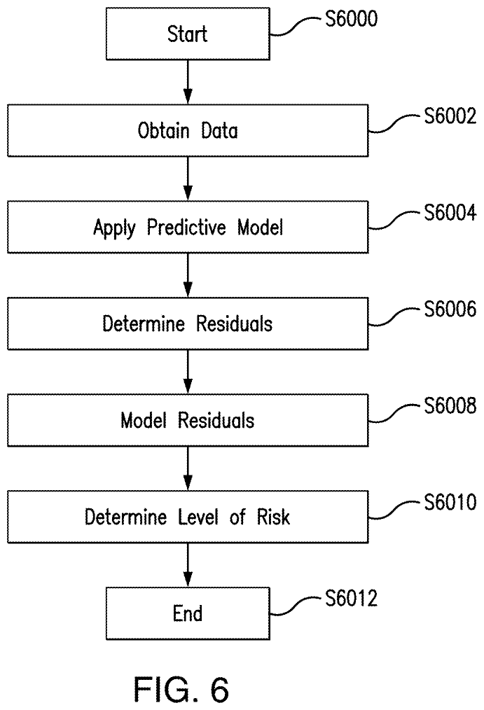

Hence more generally, a method of determining a level of risk that a future transfer will exceed a level of reserve is provided. FIG. 6 illustrates a method according to embodiments of the disclosure. The method, and associated method steps, may be carried out by an apparatus such as apparatus 1000 as described with reference to FIG. 1 of the present disclosure.

The method starts at step S6000, and proceeds to step S6002.

In step S6002, the method comprises obtaining data of transfers between financial institutions which have occurred at a number of instances of time, the data including transfer amounts.

Once the data has been obtained, the method proceeds to step S6004.

In step S6004, the method comprises applying a predictive model to the data to obtain a prediction of the transfer amount at each instance of time.

Once the predicted model has been applied to the data, the method proceeds to step S6006.

In step S6006, the method comprises determining a maximum residual between the prediction of the transfer amount and the transfer amount at each instance of time.

Having determined the maximum residuals, the method proceeds to step S6008.

In step S6008, the method comprises modelling the maximum residual for each instance of time using a generalised extreme value distribution to obtain a distribution function.

The method according to embodiments of the disclosure then proceeds to step S6010.

In step S6010, the method comprises determining the level of risk that a future transfer between financial institutions will exceed the level of reserve based on the distribution function which has been obtained.

The method then proceeds to, and ends with, step S6012.

It will be appreciated that the method according to embodiments of the disclosure is not particularly limited to the example order illustrated in FIG. 6. That is, certain method steps may be performed in a different sequence if required. For example, after determining the level of risk in step S6010, the method may return to step S6002 and obtain new data. Alternatively, multiple sets of data may be analysed following the method of FIG. 6 in parallel.

Furthermore, certain aspects of the present disclosure may be arranged in accordance with the following numbered clauses:
1. An apparatus for determining a level of risk that a future transfer will exceed a level of reserve, the apparatus comprising circuitry configured to:
obtain data of transfers between financial institutions which have occurred at a number of instances of time, the data including transfer amounts;
apply a predictive model to the data to obtain a prediction of the transfer amount at each instance of time;
determine a maximum residual between the prediction of the transfer amount and the transfer amount at each instance of time;
model the maximum residual for each instance of time using a generalised extreme value distribution to obtain a distribution function; and
determine the level of risk that a future transfer between financial institutions will exceed the level of reserve based on the distribution function which has been obtained.
2. Apparatus according to Clause 1, wherein the predicative model is a vector autoregressive moving average model and the circuitry is further configured to train the predictive model on training data of transfers between financial institutions which have occurred at a number of instances of time, the training data including transfer amounts.
3. Apparatus according to Clause 2, wherein the circuitry is further configured to apply a clustering algorithm to the training data prior to training the predictive model.
4. Apparatus according to Clause 3, wherein the clustering partitions the training data into a number of clusters, each cluster represented by one of the data within that cluster, and associates the total value of transfer amounts for data within that cluster as the transfer amount for that cluster.
5. Apparatus according to Clause 3 or 4, wherein the clustering algorithm is a k-medoids algorithm.
6. Apparatus according to any of Clauses 3 to 5, wherein the circuitry is configured to determine a number of clusters based on an average silhouette method.
7. Apparatus according to any of Clauses 2 to 6, wherein when a future transfer exceeds the level of reserve, the circuitry is further configured to include the future transfer exceeding the level of reserve in the training data to form new training data, and train the predictive model on the new training data.
8. Apparatus according to any preceding Clause, wherein the circuitry is further configured to determine the level of risk as a number for which the level of reserve is exceeded less than once in every corresponding number of instances in time.
9. Apparatus according to any preceding Clause, wherein the circuitry is configured to obtain data of interbank settlement transfers.
10. Apparatus according to any preceding Clause, wherein the circuitry is further configured to estimate a probability density function and/or a cumulative density function through maximum likelihood estimation from the distribution function, and determine the level of risk that a future transfer between financial institutions will exceed the level of reserve based on the probability density function and/or the cumulative density function.
11. Apparatus according to any preceding Clause, wherein the apparatus is configured to generate a flag based on the level of risk which has been determined.
12. Apparatus according to Clause 11, wherein the flag is indicative that a level of risk that the level of reserve will be exceeded within a predetermined period of time exceeds a predetermined threshold.
13. Apparatus according to any preceding Clause, wherein the circuitry is configured to indicate an adaptation of the level of reserve based on the level of risk which has been determined.
14. A method of determining a level of risk that a future transfer will exceed a level of reserve, the method comprising the steps of:
obtaining data of transfers between financial institutions which have occurred at a number of instances of time, the data including transfer amounts;
applying a predictive model to the data to obtain a prediction of the transfer amount at each instance of time;
determining a maximum residual between the prediction of the transfer amount and the transfer amount at each instance of time;
modelling the maximum residual for each instance of time using a generalised extreme value distribution to obtain a distribution function; and
determining the level of risk that a future transfer between financial institutions will exceed the level of reserve based on the distribution function which has been obtained.
15. A computer program product comprising instructions which, when the program is executed by a computer, cause the computer to perform a method of determining a level of risk that a future transfer will exceed a level of reserve, the method comprising:
obtaining data of transfers between financial institutions which have occurred at a number of instances of time, the data including transfer amounts;
applying a predictive model to the data to obtain a prediction of the transfer amount at each instance of time;
determining a maximum residual between the prediction of the transfer amount and the transfer amount at each instance of time;
modelling the maximum residual for each instance of time using a generalised extreme value distribution to obtain a distribution function; and
determining the level of risk that a future transfer between financial institutions will exceed the level of reserve based on the distribution function which has been obtained.

Obviously, numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

What is claimed is:

1. An apparatus for determining a level of risk that a future transfer will exceed a level of reserve, the apparatus comprising circuitry configured to:
obtain data of transfers between financial institutions which have occurred at a number of instances of time, the data including transfer amounts;
apply a predictive model to the data to obtain a prediction of the transfer amount at each instance of time;
determine a maximum residual between the prediction of the transfer amount and the transfer amount at each instance of time;
model the maximum residual for each instance of time using a generalized extreme value distribution to obtain a distribution function; and
determine the level of risk that a future transfer between financial institutions will exceed the level of reserve based on the distribution function which has been obtained.

2. The apparatus according to claim 1, wherein the predicative model is a vector autoregressive moving average model and the circuitry is further configured to train the predictive model on training data of transfers between financial institutions which have occurred at a number of instances of time, the training data including transfer amounts.

3. The apparatus according to claim 2, wherein the circuitry is further configured to apply a clustering algorithm to the training data prior to training the predictive model.

4. The apparatus according to claim 3, wherein the clustering partitions the training data into a number of clusters, each cluster represented by one of the data within that cluster, and associates the total value of transfer amounts for data within that cluster as the transfer amount for that cluster.

5. The apparatus according to claim 3, wherein the clustering algorithm is a k-medoids algorithm.

6. The apparatus according to claim 3, wherein the circuitry is configured to determine a number of clusters based on an average silhouette method.

7. The apparatus according to claims 2, wherein when a future transfer exceeds the level of reserve, the circuitry is further configured to include the future transfer exceeding the level of reserve in the training data to form new training data, and train the predictive model on the new training data.

8. The apparatus according to claim 1, wherein the circuitry is further configured to determine the level of risk as a number for which the level of reserve is exceeded less than once in every corresponding number of instances in time.

9. The apparatus according to claim 1, wherein the circuitry is configured to obtain data of interbank settlement transfers.

10. The apparatus according to claim 1, wherein the circuitry is further configured to estimate a probability density function and/or a cumulative density function through maximum likelihood estimation from the distribution function, and determine the level of risk that a future transfer between financial institutions will exceed the level of reserve based on the probability density function and/or the cumulative density function.

11. The apparatus according to claim 1, wherein the apparatus is configured to generate a flag based on the level of risk which has been determined.

12. The apparatus according to claim 11, wherein the flag is indicative that a level of risk that the level of reserve will be exceeded within a predetermined period of time exceeds a predetermined threshold.

13. The apparatus according to claim 1, wherein the circuitry is configured to indicate an adaptation of the level of reserve based on the level of risk which has been determined.

14. A method of determining a level of risk that a future transfer will exceed a level of reserve, the method comprising the steps of:
obtaining data of transfers between financial institutions which have occurred at a number of instances of time, the data including transfer amounts;
applying a predictive model to the data to obtain a prediction of the transfer amount at each instance of time;
determining a maximum residual between the prediction of the transfer amount and the transfer amount at each instance of time;
modelling the maximum residual for each instance of time using a generalized extreme value distribution to obtain a distribution function; and
determining the level of risk that a future transfer between financial institutions will exceed the level of reserve based on the distribution function which has been obtained.

15. A non-transitory computer program product comprising instructions which, when the program is executed by a computer, cause the computer to perform a method of determining a level of risk that a future transfer will exceed a level of reserve, the method comprising:
obtaining data of transfers between financial institutions which have occurred at a number of instances of time, the data including transfer amounts;
applying a predictive model to the data to obtain a prediction of the transfer amount at each instance of time;
determining a maximum residual between the prediction of the transfer amount and the transfer amount at each instance of time;
modelling the maximum residual for each instance of time using a generalized extreme value distribution to obtain a distribution function; and
determining the level of risk that a future transfer between financial institutions will exceed the level of reserve based on the distribution function which has been obtained.
